(19) United States
(12) Patent Application Publication
(10) Pub. No.: US 2010/0122310 A1
(43) Pub. Date: May 13, 2010

(54) DIGITAL BROADCAST RECEIVER

(75) Inventor: Sadatoshi Chozui, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/597,220

(22) PCT Filed: Apr. 22, 2008
(86) PCT No.: PCT/JP2008/001042

§ 371 Date: Oct. 23, 2009

(30) Foreign Application Priority Data
Apr. 27, 2007 (JP) 2007-118675

(51) Int. Cl. H04N 7/16

(52) U.S. Cl. 725/139

(57) ABSTRACT

The digital broadcast receiver, including a decoding continuation determining unit in the system control unit, does not stop decoding and outputting video and audio when determining hierarchical switching and continues decoding and outputting video and audio until the digital broadcast receiver receives given video/audio data after switching, or until the video and audio buffer accumulating video/audio data before switching becomes empty.

This application is a U.S. National Phase Application of PCT International Application PCT/JP2008/001042.

### TECHNICAL FIELD

The present invention relates to a digital broadcast receiver.

### BACKGROUND ART

Digital broadcast deals with the possibility of reception during rainfall time and in a mobile environment. As a result, digital broadcast allows hierarchical transmission simultaneously transmitting two types of services: high hierarchical service with high transmission capacity and low transmission error resistance; and low hierarchical service with low transmission capacity and high transmission error resistance. Such examples include BS digital broadcast and terrestrial digital broadcast in Japan.

A digital broadcast receiver capable of such hierarchical transmission allows viewing high hierarchical service in a favorable reception state, and then switches to low hierarchical service when the reception state deteriorates for continuous viewing.

FIG. 8 is a block diagram showing the configuration of conventional digital broadcast receiver 800. As shown in FIG. 8, conventional digital broadcast receiver 800 has a hierarchical switching function by using hierarchical switching determining unit 810. Meanwhile, digital broadcast receiver 800 is equipped with only one set of video decoder 806 and audio decoder 807. Hereinafter, a detailed description is made of the configuration of conventional digital broadcast receiver 800.

As shown in FIG. 8, conventional digital broadcast receiver 800 includes digital broadcast receiving unit 801, transport decoding unit 802, video/audio data detecting unit 803, video buffer 804, audio buffer 805, video decoder 806, audio decoder 807, video output unit 808, audio output unit 809, hierarchical switching determining unit 810, and system control unit 811.

FIG. 9 is an explanatory drawing of operation timing of hierarchical switching by conventional digital broadcast receiver 800. FIG. 10 is a flowchart illustrating operation of video switching when conventional digital broadcast receiver 800 executes hierarchical switching. Next, a description is made of hierarchical switching operation for video by conventional digital broadcast receiver 800 using FIGS. 8, 9, and 10. Here, an example is shown where conventional digital broadcast receiver 800 switches video from high hierarchical service to low one.

First, a description is made of the mechanism of MPEG-2 Systems method adopted in digital broadcast. In digital broadcast, a program clock reference and a presentation time stamp are transmitted from a broadcast station as information indicating output timing of video and audio. Here, a program clock reference becomes a reference clock for digital broadcast receiver 800 and is abbreviated as PCR hereinafter. A presentation time stamp is embedded in video/audio data for each frame and is abbreviated as PTS hereinafter. Digital broadcast receiver 800 has a system time clock (STC hereinafter) as a reference for controlling decoding video and audio and output timing of video and audio. To generate an STC, digital broadcast receiver 800 copies a PCR value in a PCR packet received to the STC counter inside. After that, the STC counter is incremented by a 27-MHz clock to reproduce the STC. If the STC has exceeded the PTS for each frame, digital broadcast receiver 800 outputs video/audio signals contained in the frames. Consequently, digital broadcast receiver 800 can output video and audio at timing intended by the broadcast station.

Thus in digital broadcast, video/audio data is typically transmitted after a certain time interval after video/audio data arrives at digital broadcast receiver 800 before an output time point indicated by the PTS. This is to allow for decoding time by the decoders (i.e. transport decoding unit 802, audio decoder 807, and video decoder 806), and for delay time in such as video buffer 804 and audio buffer 805.

Here, assumption is made that the video coding method is MPEG-2 video method for high hierarchical service and H.264 MPEG-4 AVC method for low hierarchical service. In MPEG-2 video method, video data video-decodable by itself is called an I frame. Similarly, in H.264 MPEG-4 AVC method, video data video-decodable by itself is called an IDR frame. Digital broadcast receiver 800 can start decoding video only after receiving an I frame or IDR frame.

Assuming that the audio coding method is MPEG-2 AAC method, the head of audio data is called an ADTS header in MPEG-2 AAC method. Digital broadcast receiver 800 can start decoding audio only after receiving an ADTS header.

Hereinafter, a further concrete description is made of timing where digital broadcast receiver 800 receives digital broadcast, and then decodes and outputs video and audio signals, using FIG. 9. Data reception timing diagram 951 of FIG. 9 shows data reception timing in high hierarchical service with the system time clock (STC) represented with the horizontal axis. The first “I” shown in data reception timing diagram 951 represents an I frame as a reference of the STC (STC=0) for convenience of description. Operation timing diagram 952 shows timing of outputting video and audio signals in high hierarchical service, based on a PTS embedded in video/audio data for each frame.

In other words, the first “I” shown in operation timing diagram 952 represents the first I frame for starting to output a video signal in the high hierarchical service. Thus in digital broadcast, transmission is made after a certain time interval between the first “I” shown in data reception timing diagram 951 and the first “I” shown in operation timing diagram 952, allowing for decoding time by video decoder 806 and for delay time in video buffer 804.

Further, data reception timing diagram 953 shows data reception timing in low hierarchical service for data received when it cannot be received by high hierarchical service. The first “IDR” shown in data reception timing diagram 953 represents the first IDR frame (a frame at the time point indicated by broken line 961 in the diagram) that is video-decodable by itself after starting to receive the low hierarchical service. Operation timing diagram 954 shows timing of outputting a video signal in the low hierarchical service, based on a PTS embedded in video/audio data for each frame.

In other words, the first “IDR” shown in operation timing diagram 954 represents the first IDR frame for starting (the time point indicated by broken line 965 in the figure) to output video signals in the low hierarchical service. Thus in digital broadcast, transmission is made at a certain time interval between the first “IDR” shown in data reception timing diagram 953 and the first “IDR” shown in operation timing diagram 954, allowing for decoding time by video decoder 806 and for delay time in video buffer 804. As shown in FIG. 9, decoding time by video decoder 806 is different between the high hierarchical service and the low one, and thus the above-described two certain time intervals are assumed to be different.

As described above, according to conventional digital broadcast receiver 800, the frame “I” in the high hierarchical service is reproduced in the first place as shown in operation timing diagram 955. When the reception state deteriorates, it is to be determined (the time point indicated by broken line 960 in the diagram) that switching to low hierarchical service is required. Consequently, a video signal cannot be output after reception in the high hierarchical service ceases to be received and before the IDR (the time point shown by broken line 965 in the diagram) at the first PTS after switching to the low hierarchical service.

Next, a detailed description is made of hierarchical switching operation for video by conventional digital broadcast receiver 800, using the flowchart of FIG. 10. Here, an example is shown where conventional digital broadcast receiver 800 switches video from high hierarchical service to low one.

Digital broadcast receiver 800, while decoding the high hierarchical service (step 1001), is always monitoring information related to the reception state by digital broadcast receiving unit 801 (step 1002). Then, digital broadcast receiving unit 800 is sending information related to the reception state to hierarchical switching determining unit 810. Information related to the reception state includes reception level, C/N ratio, and bit error rate. Hierarchical switching determining unit 810 determines whether or not the reception state has deteriorated from information related to the reception state, to determine whether or not hierarchical switching is executed (step 1003). If the reception state is favorable and hierarchical switching is not needed (No), digital broadcast receiver 800 continues decoding the high hierarchical service without switching the hierarchical service to be received (step 1001). Meanwhile, if hierarchical switching determining unit 810 determines that the reception state has deteriorated from information related to the reception state (Yes), hierarchical switching determining unit 810 directs system control unit 811 to switch to the low hierarchical service.

In other words, when switching to the low hierarchical service, system control unit 811 directs video decoder 806 to stop video decoding in the high hierarchical service before switching. System control unit 811 directs video decoder 806 to stop video output to video output unit 808 (step 1004). Subsequently, system control unit 811 directs transport decoding unit 802 to change setting for outputting video packets from for the high hierarchical service before switching to for the low hierarchical service after switching (step 1005). Further, system control unit 811 directs video buffer 804 to change setting for accumulating video data from for the high hierarchical service before switching to for the low hierarchical service after switching (step 1006).

Next, video/audio data detecting unit 803 of transport decoding unit 802 determines whether or not an IDR frame has been detected in video data in the low hierarchical service after switching (step 1007). If an IDR frame has not been detected (No), the process flow returns to step 1007 to repeat the operation of determining whether or not an IDR frame has been detected in video data in the low hierarchical service after switching.

Meanwhile, if an IDR frame has been detected (Yes), video/audio data detecting unit 803 informs system control unit 811 of the detection and acquires the PTS of the IDR frame from the video data (step 1008).

Next, when system control unit 811 receives the notice that an IDR frame has been detected, system control unit 811 directs video decoder 806 to start video decoding in the low hierarchical service after switching (step 1009). Then, system control unit 811 determines whether or not the STC has exceeded the PTS of the IDR frame (step 1010). If the STC has not exceeded the PTS of the IDR frame (No), the process flow returns to step 1010 to repeat the operation of determining whether or not the STC has exceeded the PTS of the IDR frame.

Meanwhile, if the STC has exceeded the PTS of the IDR frame (Yes), system control unit 811 directs video output unit 808 to start outputting video of the IDR frame (step 1011). After that, video decoding in the low hierarchical service continues (step 1012).

The above conventional example describes hierarchical switching operation for video from high hierarchical service to low one. Switching from low hierarchical service to high one follows the completely same procedure if an IDR frame is replaced with an I frame in MPEG-2 Video. Further, hierarchical switching of audio follows the completely same procedure if an IDR frame is replaced with an ADTS header.

In this way, in the above-described conventional digital broadcast receiver 800, having only one decoder, decoding of video and audio needs to be stopped once at hierarchical switching. Consequently, with digital broadcast receiver 800, video/audio output is to be stopped after decoding before switching is stopped immediately after switching determination and video output are stopped (step 1004, the time point shown by broken line 960 in FIG. 9) before given data (e.g. I frame, IDR frame, ADTS header) is received and decoded to start outputting (step 1011, the time point shown by broken line 965 in FIG. 9).

Some digital broadcast receivers have two decoders for high hierarchical service and low one to reduce time for hierarchical switching by merely switching the output (refer to patent literature 1 for example).

On the other hand, the following method is devised with a digital broadcast receiver having one decoder. That is, another video data retained in memory is used to decode video as an I frame and IDR frame until an I frame and IDR frame are received to reduce time during which video output is interrupted (refer to patent literature 2 for example).

However, with the above-described conventional digital broadcast receiver, having only one decoder, decoding of video and audio needs to be stopped once at hierarchy switching. Hence, outputting video and audio is undesirably interrupted over a long time until given data (e.g. I frame, IDR frame, ADTS header) is received and decoded to start outputting according to the PTS, after stopping decoding before switching immediately after switching determination and stopping video output.

Also, a digital broadcast receiver described in patent literature 1, having two decoders for high hierarchical service and low one, involves problems of its large scale and expensiveness

Further, a digital broadcast receiver described in patent literature 2, having one decoder, uses video data different from an actual I frame or IDR frame, and thus decoding video using the video data as a reference image results in a disturbed image to be decoded.

[Patent literature 1] Japanese Patent Unexamined Publication No. 2005-223549
[Patent literature 2] Japanese Patent Unexamined Publication No. 2006-174209

### SUMMARY OF THE INVENTION

A digital broadcast receiver according to the present invention includes a digital broadcast receiving unit receiving digital broadcast containing at least two hierarchical services; a transport decoding unit decoding digital broadcast received by the digital broadcast receiving unit and outputting a video packet in a specific hierarchical service; a video buffer accumulating a video packet output from the transport decoding unit; a video decoder decoding a video packet accumulated in the video buffer; a hierarchical switching determining unit determining a hierarchical service to be received from a reception state of the digital broadcast received by the digital broadcast receiving unit; and a system control unit controlling the hierarchical service for the video packet output from the transport decoding unit, based on the hierarchical service determined by the hierarchical switching determining unit, and controlling operation of the video decoder. The system control unit features that the video decoder stops decoding of the video packet when the transport decoding unit detects a given data after the hierarchical switching determining unit determines switching of the hierarchical service.

Such configuration provides a digital broadcast receiver capable of reducing time during which outputting video and audio is interrupted even if only one decoder is provided.

### BRIEF DESCRIPTION OF DRAWINGS

FIG. 1 is a block diagram showing the configuration of a digital broadcast receiver according to the first and second exemplary embodiments of the present invention.

FIG. 2 is a flowchart for illustrating hierarchical switching operation by a digital broadcast receiver according to the first embodiment of the present invention.

FIG. 3 is a flowchart for illustrating hierarchical switching operation by a digital broadcast receiver according to the second embodiment of the present invention.

FIG. 4 is a block diagram showing the configuration of a digital broadcast receiver according to the third and fourth exemplary embodiments of the present invention.

FIG. 5 is a flowchart for illustrating hierarchical switching operation by a digital broadcast receiver according to the third embodiment of the present invention.

FIG. 6 is a flowchart for illustrating hierarchical switching operation by a digital broadcast receiver according to the fourth embodiment of the present invention.

FIG. 7 illustrates the effect of time reduction in hierarchical switching by a digital broadcast receiver according to the embodiments first through fourth, where the horizontal axis as the time axis is represented with a system clock.

FIG. 8 is a block diagram showing the configuration of a conventional digital broadcast receiver.

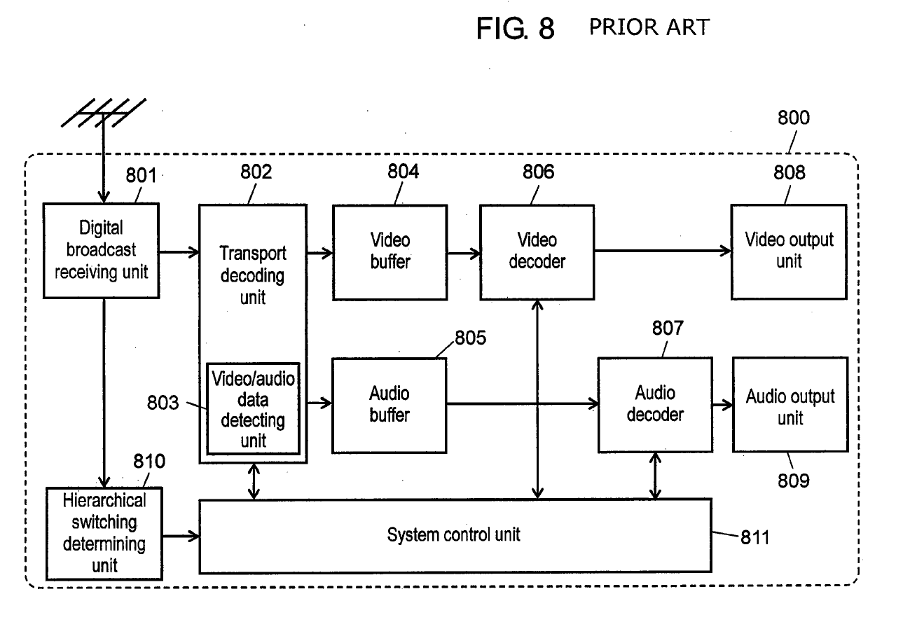

FIG. 9 is an explanatory drawing of operation timing in hierarchical switching by the conventional digital broadcast receiver.

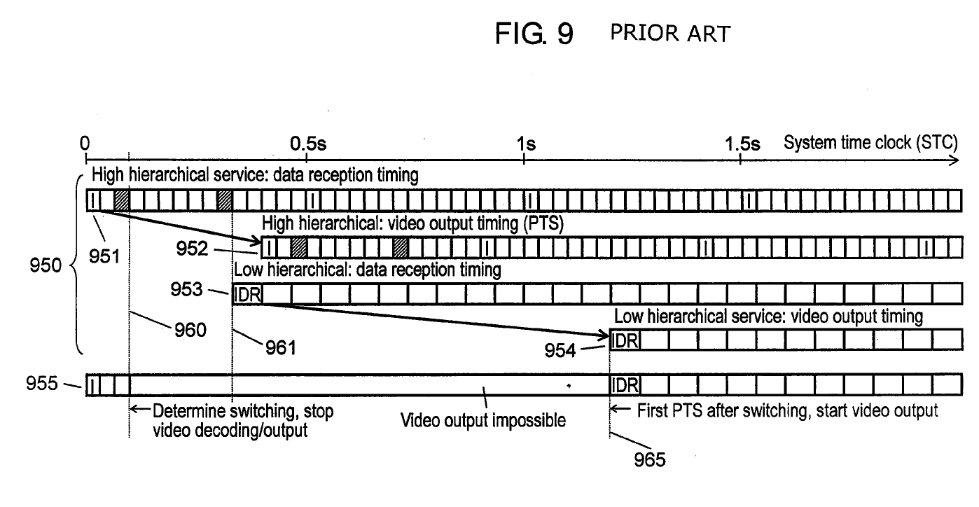

FIG. 10 is a flowchart for illustrating hierarchical switching operation by the conventional digital broadcast receiver.

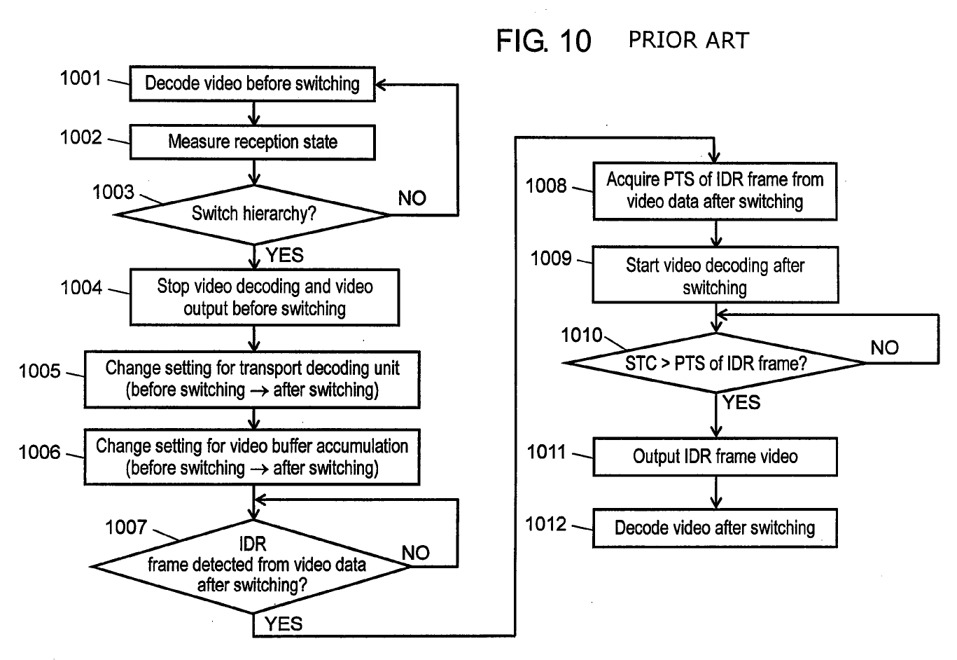

### REFERENCE MARKS IN THE DRAWINGS

100 Digital broadcast receiver
101 Digital broadcast receiving unit
102 Transport decoding unit
103 Video/audio data detecting unit
104 Video buffer
105 Audio buffer
106 Video decoder
107 Audio decoder
108 Video output unit
109 Audio output unit
110 Hierarchical switching determining unit
111 System control unit
112 Decoding continuation determining unit
113 Buffer accumulation determining unit
400 Digital broadcast receiver
1041 First video buffer
1042 Second video buffer
1051 First audio buffer
1052 Second audio buffer

### DETAILED DESCRIPTION OF PREFERRED EMBODIMENTS

Hereinafter, a description is made of some exemplary embodiments of the present invention using the related drawings.

### First Exemplary Embodiment

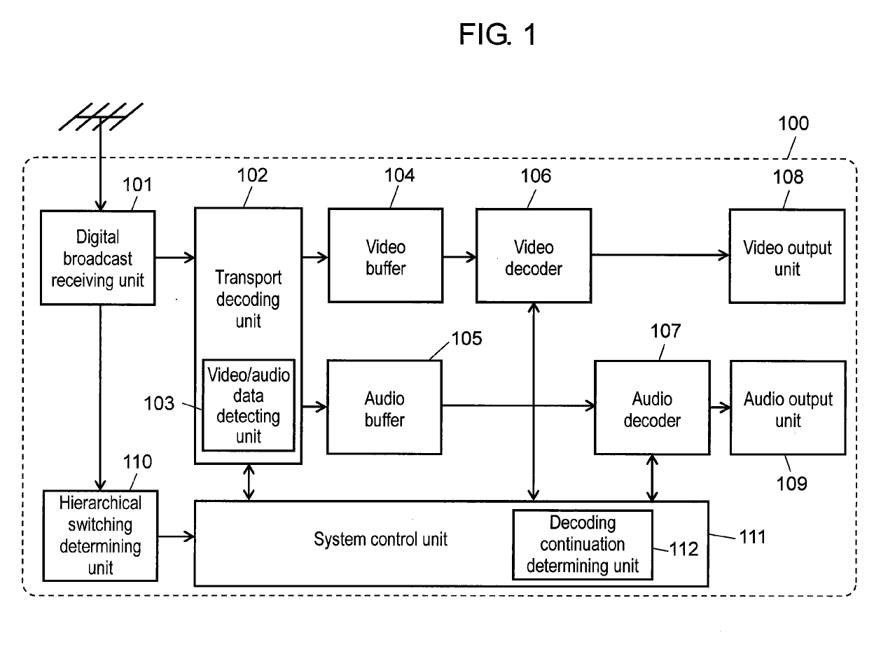

FIG. 1 is a block diagram showing the configuration of digital broadcast receiver 100 according to the first exemplary embodiment of the present invention. As shown in FIG. 1, digital broadcast receiver 100 includes digital broadcast receiving unit 101, transport decoding unit 102, video/audio data detecting unit 103, video buffer 104, audio buffer 105, video decoder 106, audio decoder 107, video output unit 108, audio output unit 109, hierarchical switching determining unit 110, system control unit 111, and decoding continuation determining unit 112. Here, video/audio data detecting unit 103 is contained in transport decoding unit 102. Decoding continuation determining unit 112 is contained in system control unit 111.

Next, a description is made of operation of digital broadcast receiver 100 thus structured. Digital broadcast receiving unit 101 of digital broadcast receiver 100 receives digital broadcast containing at least two hierarchical services. Transport decoding unit 102 decodes digital broadcast received by digital broadcast receiving unit 101 to output video packets in specific hierarchical service. Video buffer 104 accumulates video packets output from transport decoding unit 102. Then, video decoder 106 decodes video packets accumulated in video buffer 104. Hierarchical switching determining unit 110 determines hierarchical service to be received from a reception state of digital broadcast received by digital broadcast receiving unit 101. Then, system control unit 111 controls the hierarchical service for video packets output from transport decoding unit 102, based on the hierarchical service determined by hierarchical switching determining unit 110, and controls operation of video decoder 106.

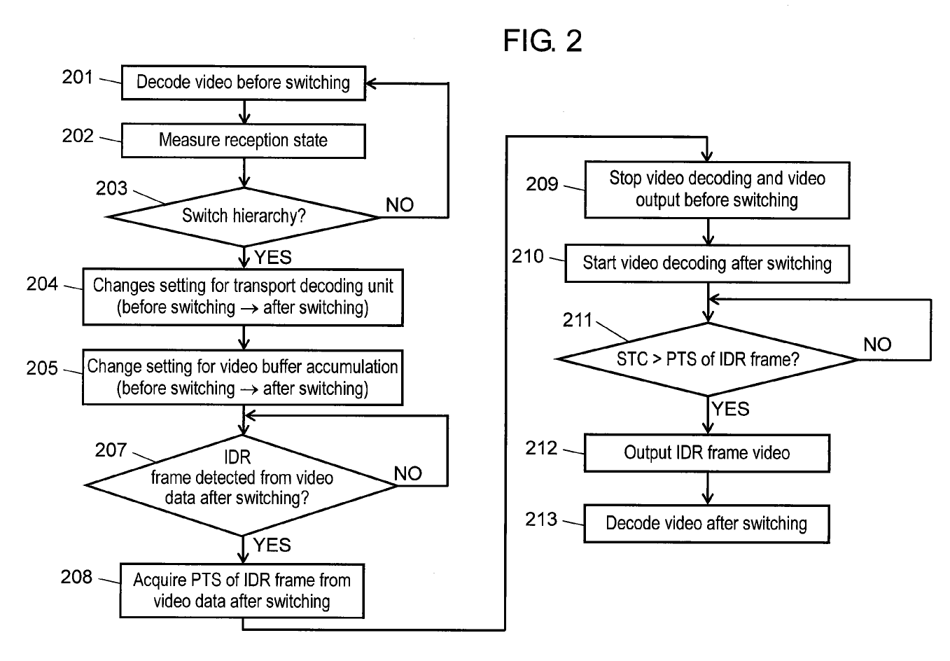

FIG. 2 is a flowchart for illustrating hierarchical switching operation by a digital broadcast receiver according to the first embodiment. Next, a description is made of hierarchical switching operation for video by digital broadcast receiver 100, using FIGS. 1 and 2. In the first embodiment, an example is shown where digital broadcast receiver 100 executes hierarchical switching for video from high hierarchical service to low one.

Digital broadcast receiver 100, while decoding the high hierarchical service (step 201), is always monitoring information related to the reception state by digital broadcast receiving unit 101 (step 202). Then, digital broadcast receiving unit 101 is sending information related to the reception state to hierarchical switching determining unit 110. Information related to the reception state includes reception level, C/N ratio, and bit error rate, for example. Hierarchical switching determining unit 110 determines whether the reception state has deteriorated from information related to the reception state to determine whether hierarchical switching is to be executed (step 203). If the reception state is favorable and hierarchical switching is not needed (No), digital broadcast receiver 100 does not switch the hierarchical service to be received but continues decoding the high hierarchical service (step 201). Meanwhile, if hierarchical switching determining unit 110 determines that the reception state has deteriorated from information related to the reception state (Yes), hierarchical switching determining unit 110 directs system control unit 111 to switch to the low hierarchical service.

Then, decoding continuation determining unit 112 determines that video decoding in the high hierarchical service before switching is continued when system control unit 111 is directed to switch from the high hierarchical service to the low one by hierarchical switching determining unit 110. Hence, system control unit 111 does not direct video decoder 106 to stop decoding and does not direct video output unit 108 to stop video output even if system control unit 111 is directed to switch from the high hierarchical service to the low one. Meanwhile, system control unit 111 directs transport decoding unit 102 to change setting from for outputting video packets in the high hierarchical service before switching to that in the low hierarchical service after switching (step 204). Subsequently, system control unit 111 changes setting from for accumulating video data in the high hierarchical service before switching in video buffer 104 to that in the low hierarchical service after switching (step 205).

Next, video/audio data detecting unit 103 of transport decoding unit 102 determines whether or not an IDR frame by H.264 MPEG-4 AVC method as given data has been detected from video data in the low hierarchical service after switching (step 207). If an IDR frame has not been detected from the video data in the low hierarchical service after switching (No), the process flow returns to step 207 to repeat the operation of determining whether or not an IDR frame has been detected from the video data in the low hierarchical service after switching. Meanwhile, if an IDR frame has been detected from the video data in the low hierarchical service after switching (Yes), video/audio data detecting unit 103 informs system control unit 111 of the detection and acquires the PTS of the IDR frame from the video data (step 208).

Then, decoding continuation determining unit 112 of system control unit 111 that has been informed that video/audio data detecting unit 103 has detected an IDR frame determines to stop video decoding and video output. System control unit 111 directs video decoder 106 to stop video decoding in the high hierarchical service before switching, and also directs video output unit 108 to stop video output (step 209).

After that, system control unit 111 directs to start video decoding in the low hierarchical service after switching (step 210). Then, system control unit 111 determines whether the STC has exceeded the PTS of the IDR frame (step 211). If the STC has not exceeded the PTS of the IDR frame (No), the process flow returns to step 211. Meanwhile, if the STC has exceeded the PTS of the IDR frame (Yes), system control unit 111 directs video output unit 108 to start video output for the IDR frame (step 212). After that, system control unit 111 continues video decoding in the low hierarchical service (step 213).

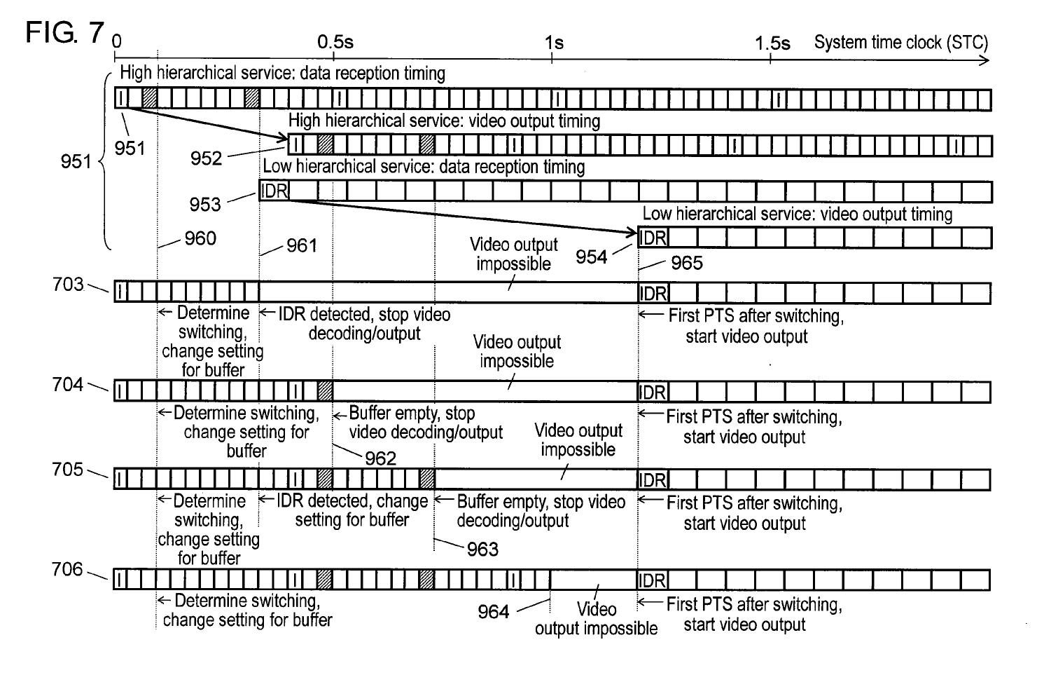

FIG. 7 is an explanatory drawing of the effect of time reduction in hierarchical switching by digital broadcast receiver 100 according to the embodiment of the present invention, where the horizontal axis as the time axis is represented with a system clock. FIG. 7 shows operation timing diagram 703 of hierarchical switching by digital broadcast receiver 100 according to the first embodiment. FIG. 7 additionally shows data reception timing diagrams 951 and 953 and operation timing diagrams 952 and 954 in digital broadcast already described. As described already, data reception timing diagrams 951 and 953 indicate timing required to decode digital signals for high hierarchical service transmitted from a broadcast station and to output them. Operation timing diagrams 952, 954 indicate a reference for digital broadcast receiver 100 to control such as decoding and output timing of video and audio.

As described above, using the flowchart of FIG. 2, digital broadcast receiver 100 according to the first embodiment continues video decoding and video output before switching the hierarchical service even after determining the hierarchical switching (the time point shown by broken line 960, step 204 in FIG. 2), when switching from the high hierarchical service to the low one. Then, digital broadcast receiver 100 stops video decoding and video output after detecting an IDR frame in the low hierarchical service after switching the hierarchical service (the time point shown by broken line 961, step 209 in FIG. 2).

Then, digital broadcast receiver 100 determines whether the STC has exceeded the PTS of the IDR frame by system control unit 111. If the STC has exceeded the PTS of the IDR frame, system control unit 111 directs video output unit 108 to start video output for the IDR frame (the time point shown by broken line 965, step 212 in FIG. 2). Controlling in this way allows digital broadcast receiver 100 according to the first embodiment to reduce time during which output of video and audio is interrupted at hierarchical switching. Specifically, time during which output of video and audio is interrupted at hierarchical switching can be reduced by the period shown by broken lines 960 and 961.

As described above, system control unit 111 of digital broadcast receiver 100 according to the first embodiment stops decoding video packets by video decoder 106 when transport decoding unit 102 detects an IDR frame as given data, after hierarchical switching determining unit 110 has determined switching the hierarchical service. Controlling in this way allows digital broadcast receiver 100 according to the first embodiment to reduce time during which output of video and audio is interrupted at hierarchical switching.

As described above, the first embodiment describes hierarchical switching operation for video from high hierarchical service to low one. However, the present invention is applicable to switching from low hierarchical service to high one in the completely same procedure by replacing an IDR frame as given data with an I frame by MPEG-2 video method. By doing in this way, the present invention provides the same effect in switching from low hierarchical service to high one.

For hierarchical switching of audio, the present invention is applicable in the completely same procedure if an IDR frame as given data is replaced with an ADTS header by H.264 MPEG-4 AVC method. That is, as described above, digital broadcast receiver 100 is equipped with audio buffer 105 accumulating audio packets; and audio decoder 107 decoding audio packets accumulated in audio buffer 105. Then, transport decoding unit 102 decodes digital broadcast received by digital broadcast receiving unit 101 to output audio packets in specific hierarchical service to audio buffer 105. Then, system control unit 111 stops decoding audio packets by audio decoder 107 when transport decoding unit 102 detects an ADTS header by MPEG-2 AAC method as given data, after hierarchical switching determining unit 110 has determined switching the hierarchy. Controlling in this way allows digital broadcast receiver 100 according to the first embodiment to reduce time during which output of video and audio is interrupted at hierarchical switching.

### Second Exemplary Embodiment

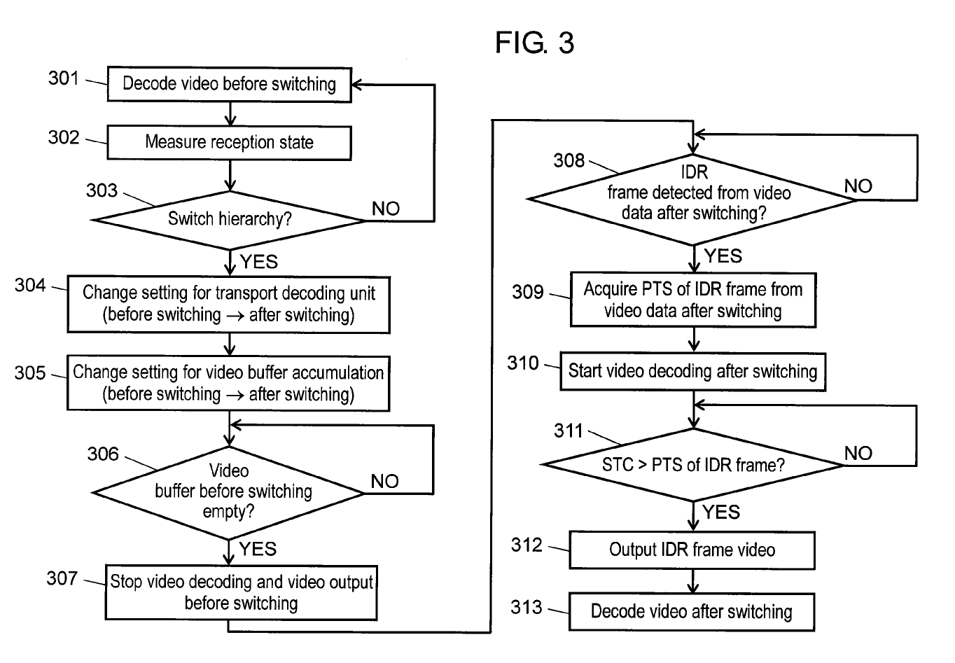

In the second exemplary embodiment, the block diagram showing the configuration is FIG. 1 in the same way as in the first embodiment. FIG. 3 is a flowchart for illustrating hierarchical switching operation by digital broadcast receiver 100 according to the second embodiment. The second embodiment is different from the first one in that video decoding and video output are stopped when video decoder 106 has detected that video data before switching accumulated in video buffer 104 has been emptied. Hence, a detailed description is omitted of a component and its operation same as those in the first embodiment.

Next, a description is made of hierarchical switching operation for video by digital broadcast receiver 100 using FIGS. 1 and 3. In the second embodiment, an example is shown where digital broadcast receiver 100 switches the hierarchy for video from high hierarchical service to low one. The procedure is common with the first embodiment from when digital broadcast receiver 100 is decoding the high hierarchical service (step 301), until when system control unit 111 changes setting from for accumulating video data in the high hierarchical service before switching in video buffer 104 to that in the low hierarchical service after switching (step 305), and thus a detailed description for the procedure is omitted.

After that, video decoder 106 determines whether video data before switching accumulated in video buffer 104 has been emptied (step 306). If video data before switching has not been emptied (No), the control process returns to step 306 to repeat the determining operation. Meanwhile, if video data before switching has been emptied (Yes), video decoder 106 informs system control unit 111 that video data before switching has been emptied. Then, decoding continuation determining unit 112 of system control unit 111 that has received the notice determines stopping video decoding and video output. Then, system control unit 111 directs video decoder 106 to stop video decoding in the high hierarchical service before switching, and directs video output unit 108 to stop video output (step 307).

Next, video/audio data detecting unit 103 of transport decoding unit 102 determines whether an IDR frame has been detected from video data in the low hierarchical service after switching (step 308). If an IDR frame has not been detected, the control flow returns to step 308 to repeat the determining operation. Meanwhile, if an IDR frame is (or has been already) detected from the video data in the low hierarchical service after switching (Yes), video/audio data detecting unit 103 informs system control unit 111 of the detection and acquires the PTS of the IDR frame from the video data (step 309).

Then, system control unit 111 that has received the notice directs to start video decoding in the low hierarchical service after switching (step 310). Next, system control unit 111 determines whether the STC has exceeded the PTS of the IDR frame (step 311). If the STC has not exceeded the PTS of the IDR frame (No), the control flow returns to step 311 to repeat the determining operation. Meanwhile, if the STC has exceeded the PTS of the IDR frame (Yes), system control unit 111 directs video output unit 108 to start video output of the IDR frame (step 312). After that, video decoding in the low hierarchical service is continued (step 313).

FIG. 7 is an explanatory drawing of the effect of time reduction in hierarchical switching by digital broadcast receiver 100 according to the embodiment of the present invention, where the horizontal axis as the time axis is represented with a system clock. FIG. 7 additionally shows operation timing diagram 704 in hierarchical switching by digital broadcast receiver 100 according to the second embodiment.

As described above using the flowchart of FIG. 3, digital broadcast receiver 100 according to the second embodiment continues video decoding and video output before switching the hierarchical service, even after determining (the time point shown by broken line 960, step 304 in FIG. 3) hierarchical switching, when switching from the high hierarchical service to the low one. Then, digital broadcast receiver 100 stops video decoding and video output after detecting that video data before switching accumulated in video buffer 104 has been emptied (the time point shown by broken line 962, step 307 in FIG. 3).

Then, digital broadcast receiver 100 determines whether the STC has exceeded the PTS of the IDR frame by system control unit 111. If the STC has exceeded the PTS of the IDR frame, system control unit 111 directs video output unit 108 to start video output of an IDR frame (the time point shown by broken line 965, step 312 in FIG. 3). Controlling in this way allows digital broadcast receiver 100 according to the second embodiment to reduce time during which output of video and audio is interrupted at hierarchical switching. Specifically, time during which output of video and audio is interrupted at hierarchical switching can be reduced by the period shown by broken lines 960 and 962. That is, the second embodiment is more advantageous than the first in reducing time during which output of video and audio is interrupted at hierarchical switching.

As described above, system control unit 111 of digital broadcast receiver 100 according to the first embodiment includes: digital broadcast receiving unit 101 receiving digital broadcast containing at least two hierarchical services; transport decoding unit 102 decoding digital broadcast received by digital broadcast receiving unit 101 to output video packets in specific hierarchical service; video buffer 104 accumulating video packets output from transport decoding unit 102; video decoder 106 decoding video packets accumulated in video buffer 104; hierarchical switching determining unit 110 determining hierarchical service to be received from a reception state of the digital broadcast received by digital broadcast receiving unit 101; and system control unit 111 controlling hierarchical service for video packets output from transport decoding unit 102, based on the hierarchical service determined by hierarchical switching determining unit 110, and controlling operation of video decoder 106. Then, system control unit 111 stops decoding video packets by video decoder 106 when video packets in the hierarchical service before switching are emptied from video buffer 104, after hierarchical switching determining unit 110 has determined switching the hierarchical service. Controlling in this way allows digital broadcast receiver 100 according to the first embodiment to reduce time during which output of video and audio is interrupted at hierarchical switching.

Further, for hierarchical switching of audio, the present invention is applicable in the completely same procedure if an IDR frame as given data is replaced with an ADTS header by H.264 MPEG-4 AVC method. That is, as described above, digital broadcast receiver 100 is equipped with audio buffer 105 accumulating audio packets; and audio decoder 107 decoding audio packets accumulated in audio buffer 105. Then, transport decoding unit 102 decodes digital broadcast received by digital broadcast receiving unit 101 to output audio packets in specific hierarchical service to audio buffer 105. System control unit 111 stops decoding audio packets by audio decoder 107 when audio packets in the hierarchical service before switching are emptied from audio buffer 105, after hierarchical switching determining unit 110 has determined switching the hierarchical service. Controlling in this way allows digital broadcast receiver 100 according to the second embodiment to reduce time during which output of video and audio is interrupted at hierarchical switching.

Further, as described above, the present invention is applicable to the second embodiment in the completely same procedure for hierarchical switching of video and audio from low hierarchical service to high one. The second embodiment is more advantageous than the first in reducing time during which output of video and audio is interrupted at hierarchical switching.

### Third Exemplary Embodiment

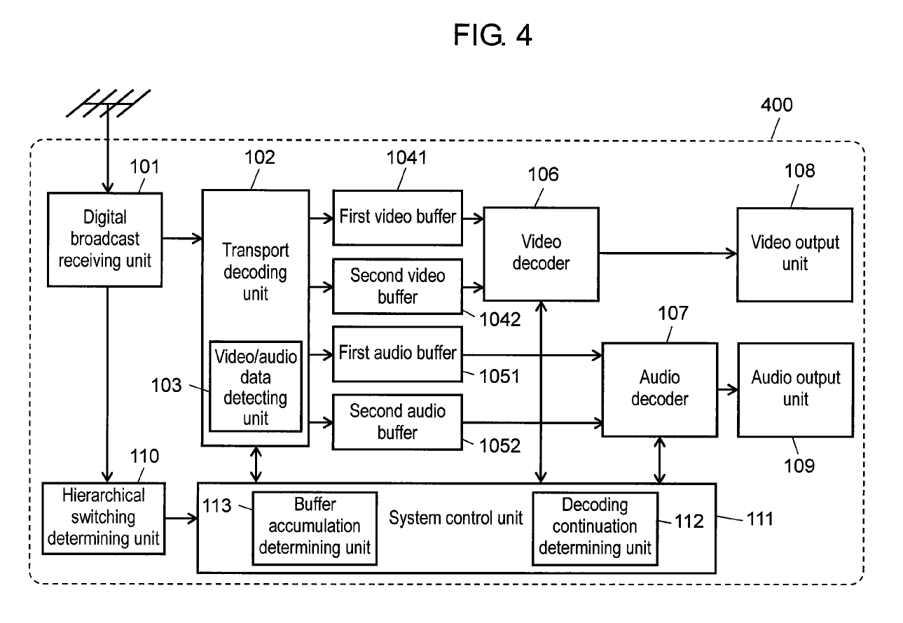

FIG. 4 is a block diagram of digital broadcast receiver 400 according to the third exemplary embodiment of the present invention. As shown in FIG. 4, digital broadcast receiver 400 according to the third embodiment is different from digital broadcast receiver 100 according to the first embodiment shown in FIG. 1 in that digital broadcast receiver 400 includes first video buffer 1041, second video buffer 1042, first audio buffer 1051, and second audio buffer 1052 so as to accumulate video/audio data both before and after hierarchical switching, and that system control unit 111 includes buffer accumulation determining unit 113. Here, first video buffer 1041 accumulates video data before hierarchical switching; second video buffer 1042, after. First audio buffer 1051 accumulates audio data before hierarchical switching; second audio buffer 1052, after. The other components are the same as those in the first embodiment. Hence, a detailed description is omitted for a component and its operation same as those in the first embodiment.

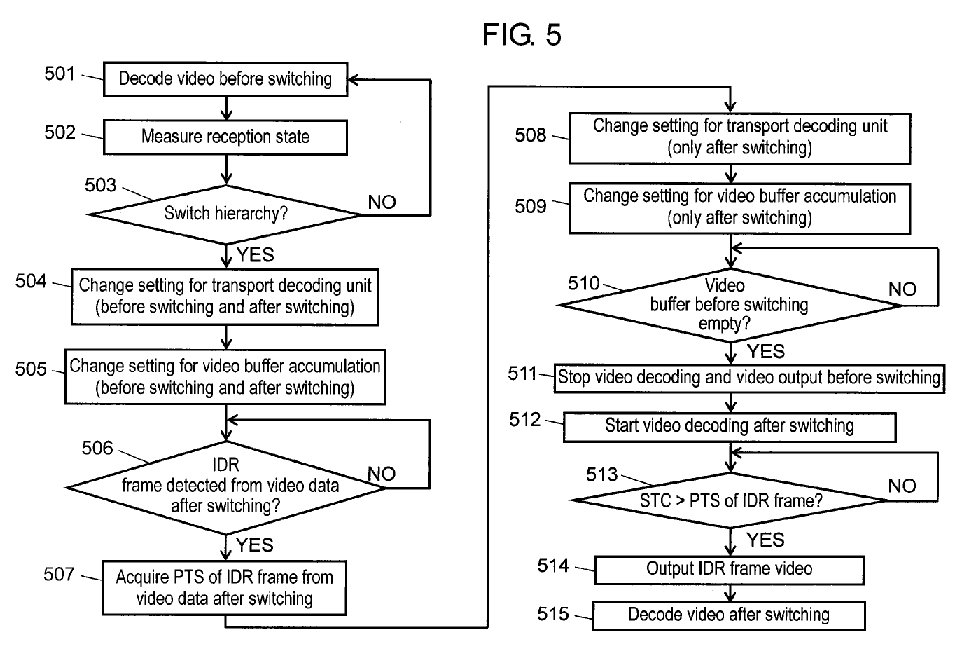

FIG. 5 is a flowchart illustrating hierarchical switching operation by digital broadcast receiver 400 according to the third embodiment. Next, a description is made of hierarchical switching operation for video by digital broadcast receiver 400 using FIGS. 4 and 5. In the third embodiment, an example is shown where digital broadcast receiver 400 executes hierarchical switching for video from high hierarchical service to low one.

The operation is common with the first embodiment from when digital broadcast receiver 400 is decoding the high hierarchical service (step 501), until when system control unit 111 does not direct video decoder 106 to stop decoding and does not direct video output unit 108 to stop video output even if system control unit 111 receives a direction for hierarchical switching.

After that, buffer accumulation determining unit 113 of system control unit 111 determines that video data both before and after switching needs to be processed. System control unit 111 directs transport decoding unit 102 to add setting for outputting video packets in the high hierarchical service before switching, and setting for outputting video packets in the low hierarchical service after switching (step 504). Then, system control unit 111 directs transport decoding unit 102 to add setting for accumulating video data in the high hierarchical service before switching in first video buffer 1041, and setting for accumulating video data in the low hierarchical service after switching in second video buffer 1042 (step 505).

Video/audio data detecting unit 103 of transport decoding unit 102 determines whether an IDR frame has been detected from video data in the low hierarchical service after switching (step 506). If an IDR frame has not been detected, the control flow returns to step 506 to repeat the determining operation. Meanwhile, if video/audio data detecting unit 103 detects an IDR frame in the low hierarchical service after switching from the video data (Yes), video/audio data detecting unit 103 informs system control unit 111 of the detection of the IDR frame and acquires the PTS of the IDR frame from the video data (step 507).

Then, buffer accumulation determining unit 113 of system control unit 111 that has received the notice of the detection of an IDR frame determines that video data both before and after switching does not need to be processed any longer. System control unit 111 directs transport decoding unit 102 to change setting from for outputting video packets for both before and after switching to that in the low hierarchical service after switching (step 508). Then, system control unit 111 changes setting from for accumulating video data both before and after switching in first video buffer 1041 and second video buffer 1042, respectively, to that in the low hierarchical service after switching in second video buffer 1042 (step 509).

Next, video decoder 106 determines whether video data before switching accumulated in video buffer 1041 has been emptied (step 510). If video data before switching has not been emptied (No), the control process returns to step 510 to repeat the determining operation. Meanwhile, if video data before switching has been emptied (Yes), video decoder 106 informs system control unit 111 that video data before switching has been emptied.

Then, decoding continuation determining unit 112 of system control unit 111 that has received the notice determines to stop video decoding and video output. System control unit 111 directs video decoder 106 to stop video decoding in the high hierarchical service before switching and directs video output unit 108 to stop video output, based on the determination (step 511). Subsequently, system control unit 111 directs to start video decoding in the low hierarchical service after switching (step 512).

Next, system control unit 111 determines whether the STC has exceeded the PTS of the IDR frame (step 513). If the STC has not exceeded the PTS of the IDR frame (No), the control flow returns to step 513 to repeat the determining operation. Meanwhile, if the STC has exceeded the PTS of the IDR frame (Yes), system control unit 111 directs video output unit 108 to start video output of an IDR frame (step 514). After that, video decoding in the low hierarchical service is continued (step 515).

FIG. 7 is an explanatory drawing of the effect of time reduction in the hierarchical switching by digital broadcast receivers 100 and 400 according to the embodiment of the present invention, where the horizontal axis as the time axis is represented with a system clock. FIG. 7 additionally shows operation timing diagram 705 in hierarchical switching by digital broadcast receiver 400 according to the third embodiment.

As described above using the flowchart of FIG. 5, digital broadcast receiver 400 according to the third embodiment continues accumulating video data, video decoding, and video output before switching, even after determining (the time point shown by broken line 960, step 504 in FIG. 5) hierarchical switching. Then, digital broadcast receiver 400 stops accumulating video data after detecting an IDR frame after switching the hierarchical service, and stops video decoding and video output after detecting that video data before switching accumulated in the video buffer has been emptied (the time point shown by broken line 963, step 511 in FIG. 5).

Then, digital broadcast receiver 400 determines whether the STC has exceeded the PTS of the IDR frame by system control unit 111. If the STC has exceeded the PTS of the IDR frame, system control unit 111 directs video output unit 108 to start video output of an IDR frame (the time point shown by broken line 965, step 514 in FIG. 2). Controlling in this way allows digital broadcast receiver 400 according to the third embodiment to reduce time during which output of video and audio is interrupted at hierarchical switching. Specifically, time during which output of video and audio is interrupted at hierarchical switching can be reduced by the period shown by broken lines 960 and 963. That is, the third embodiment is more advantageous than the second in reducing time during which output of video and audio is interrupted at hierarchical switching.

As described above, system control unit 111 of digital broadcast receiver 400 according to the third embodiment includes: digital broadcast receiving unit 101 receiving digital broadcast containing at least two hierarchical services; transport decoding unit 102 decoding digital broadcast received by digital broadcast receiving unit 101 to output video packets in high and low hierarchical services; first video buffer 1041 accumulating video packets in the high hierarchical service output from transport decoding unit 102; second video buffer 1042 accumulating video packets in the low hierarchical service output from transport decoding unit 102; video decoder 106 decoding video packets accumulated in first video buffer 1041 or second video buffer 1042; hierarchical switching determining unit 110 determining hierarchical service to be received from a reception state of the digital broadcast received by digital broadcast receiving unit 101; and system control unit 111 controlling hierarchical service for video packets output from transport decoding unit 102, based on the hierarchical service determined by hierarchical switching determining unit 110, and controlling operation of video decoder 106. Then, system control unit 111 stops decoding video packets before switching by video decoder 106 when a video buffer before switching out of first video buffer 1041 and second video buffer 1042 is emptied, when transport decoding unit 102 detects an IDR frame as given data, after hierarchical switching determining unit 110 has determined switching the hierarchical service. Controlling in this way allows digital broadcast receiver 400 according to the third embodiment to reduce time during which output of video and audio is interrupted at hierarchical switching.

Further, for hierarchical switching of audio, the present invention is applicable in the completely same procedure if an IDR frame as given data is replaced with an ADTS header by H.264 MPEG-4 AVC method. That is, as described above, digital broadcast receiver 400 is equipped with first audio buffer 1051 accumulating audio packets in high hierarchical service; second audio buffer 1052 accumulating audio packets in low hierarchical service; and audio decoder 107 decoding audio packets accumulated in first audio buffer 1051 or second audio buffer 1052. Then, transport decoding unit 102 decodes digital broadcast received by digital broadcast receiving unit 101 to output audio packets in the high hierarchical service and the low one to first audio buffer 1051 and second audio buffer 1052, respectively. Then, system control unit 111 stops decoding audio packets before switching by audio decoder 107 when a video buffer before switching out of first video buffer 1051 and second video buffer 1052 is emptied, when transport decoding unit 102 detects an ADTS header by MPEG-2 AAC method as given data, after hierarchical switching determining unit 110 has determined switching the hierarchy. Controlling in this way allows digital broadcast receiver 400 according to the first embodiment to reduce time during which output of video and audio is interrupted at hierarchical switching.

As described above, the present invention is applicable to the third embodiment in the completely same procedure for hierarchical switching of video and audio from low hierarchical service to high one. That is, the present invention is applicable to switching from low hierarchical service to high one in the completely same procedure by replacing an IDR frame as given data with an I frame by MPEG-2 video method. The third embodiment is more advantageous than the second in reducing time during which output of video and audio is interrupted at hierarchical switching.

### Fourth Exemplary Embodiment

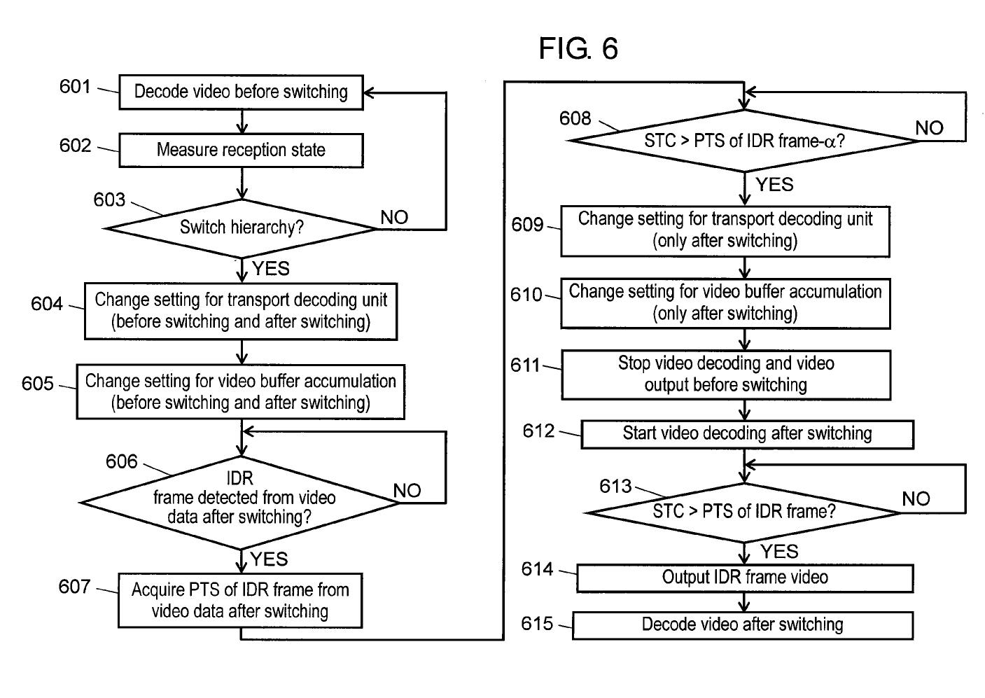

In the fourth exemplary embodiment, the block diagram showing the configuration is FIG. 4 similarly to the third embodiment. FIG. 6 is a flowchart for illustrating hierarchical switching operation by digital broadcast receiver 400 according to the fourth embodiment. The fourth embodiment is different from the third in that system control unit 111 directs video decoder 106 to decode video in the high hierarchical service before switching and directs video output unit 108 to output video until the time point that is the PTS minus first given time a (a time period required for video decoder 106 to decode video of an IDR frame after switching). Hence, a detailed description is omitted for a component and its operation same as those in the third embodiment.

First, a description is made of hierarchical switching operation for video from high hierarchical service to low one using FIGS. 4 and 6. The operation is common with the third embodiment from when digital broadcast receiver 400 is decoding high hierarchical service (step 601), until when video/audio data detecting unit 103 detects an IDR frame after switching and acquires the PTS (step 607).

After that, determination is made whether the STC has exceeded the time point that is the PTS of an IDR frame minus first given time α (a time period required for the video decoder to decode video of an IDR frame) (step 608). If the STC has not exceeded the time point that is the PTS of an IDR frame minus first given time α (No), the control flow returns to step 608 to repeat the determining operation. Meanwhile, if detected that the STC has exceeded the time point that is the PTS of an IDR frame minus first given time α (Yes), buffer accumulation determining unit 113 of system control unit 111 determines that video data both before and after switching does not need to be processed any longer. At this moment, system control unit 111 directs transport decoding unit 102 to change setting from for outputting video packets for both before and after switching to that in the low hierarchical service after switching (step 609). Consequently, system control unit 111 changes setting from for accumulating video data both before and after switching in first video buffer 1041 and second video buffer 1042, respectively, to that in the low hierarchical service after switching in second video buffer 1042 (step 610).

Further, decoding continuation determining unit 112 of system control unit 111 determines to stop video decoding and video output at this time. System control unit 111 directs video decoder 106 to stop video decoding in the high hierarchical service before switching and directs video output unit 108 to stop video output based on the determination (step 611). Subsequently, system control unit 111 directs to start the low hierarchical service after switching (step 612). Determination is made whether the STC has exceeded the PTS of the IDR frame (step 613).

If the STC has not exceeded the PTS of the IDR frame, (No), the control flow returns to step 613 to repeat the determining operation. Meanwhile, if detected that the STC has exceeded the PTS of the IDR frame (Yes), system control unit 111 directs video output unit 108 to start video output of an IDR frame (step 614). After that, video decoding in the low hierarchical service is continued (step 615).

FIG. 7 is an explanatory drawing of the effect of time reduction in hierarchical switching by digital broadcast receiver 400 according to the fourth embodiment of the present invention, where the horizontal axis as the time axis is represented with a system clock. FIG. 7 additionally shows operation timing diagram 706 in hierarchical switching by digital broadcast receiver 400 according to the fourth embodiment.

As described above using the flowchart of FIG. 6, digital broadcast receiver 400 according to the fourth embodiment continues video data accumulation, video decoding, and video output before switching, even after determining hierarchical switching when switching from the high hierarchical service to the low one. Then, digital broadcast receiver 400 stops data accumulation, video decoding, and video output before switching at a given time point that is the PTS minus a time period required to decode video of an IDR frame after switching (the time point shown by broken line 964, step 611 in FIG. 6). This reduces time during which output of video and audio is interrupted at hierarchical switching. Specifically, time during which output of video and audio is interrupted at hierarchical switching can be reduced by the period shown by broken lines 960 and 964. That is, the fourth embodiment is more advantageous than the third in reducing time during which output of video and audio is interrupted at hierarchical switching.

As described above, digital broadcast receiver 400 according to the fourth embodiment includes: digital broadcast receiving unit 101 receiving digital broadcast containing at least two hierarchical services; transport decoding unit 102 decoding digital broadcast received by digital broadcast receiving unit 101 to output video packets for high and low hierarchical services; first video buffer 1041 accumulating video packets in the high hierarchical service output from transport decoding unit 102; second video buffer 1042 accumulating video packets in the low hierarchical service output from transport decoding unit 102; video decoder 106 decoding video packets accumulated in first video buffer 1041 or second video buffer 1042; hierarchical switching determining unit 110 determining hierarchical service to be received from a reception state of the digital broadcast received by digital broadcast receiving unit 101; and system control unit 111 controlling hierarchical service for video packets output from transport decoding unit 102, based on the hierarchical service determined by hierarchical switching determining unit 110, and controlling operation of video decoder 106. Then, system control unit 111 stops decoding video packets before switching by video decoder 106 at the given time point, after hierarchical switching determining unit 110 has determined to switch the hierarchical service. Then, transport decoding unit 102 has detected an IDR frame as given data. Here, the given time is the time point that is the PTS of the IDR frame minus first given time α. First given time α is a time period required for video decoder 106 to decode video of an IDR frame by H.264 MPEG-4 AVC method. Controlling in this way allows digital broadcast receiver 400 according to the fourth embodiment to reduce time during which output of video and audio is interrupted at hierarchical switching.

Further, for hierarchical switching of audio, the present invention is applicable in the completely same procedure if an IDR frame as given data showed in FIG. 7, is replaced with an ADTS header by H.264 MPEG-4 AVC method. That is, as described above, digital broadcast receiver 400 is equipped with first audio buffer 1051 accumulating audio packets in high hierarchical service; second audio buffer 1052 accumulating audio packets in low hierarchical service; and audio decoder 107 decoding audio packets accumulated in first audio buffer 1051 or second audio buffer 1052. Then, transport decoding unit 102 decodes digital broadcast received by digital broadcast receiving unit 101 to output audio packets in the high hierarchical service and the low one to first audio buffer 1051 and second audio buffer 1052, respectively. System control unit 111 stops decoding audio packets by the audio decoder 107 at the given time point, after hierarchical switching determining unit 110 has determined to switch the hierarchical service. Then, transport decoding unit 102 has detected an IDR frame as given data. Here, the given time is the time point that is the PTS of the IDR frame minus second given time β. Second given time 3 is a time period required for audio decoder 107 to decode audio of an ADTS header by MPEG-2 AAC method. Second given time 13 for audio decoder 107 corresponds to first given time α for video decoder 106. Controlling in this way allows digital broadcast receiver 400 according to the fourth embodiment to reduce time during which output of video and audio is interrupted at hierarchical switching.

As described above, the present invention is applicable to the fourth embodiment in the completely same procedure for hierarchical switching of video and audio from low hierarchical service to high one. The fourth embodiment is more advantageous than the third in reducing time during which output of video and audio is interrupted at hierarchical switching.

### INDUSTRIAL APPLICABILITY

A digital broadcast receiver of the present invention offers an advantage in that time during which output of video and audio is interrupted at hierarchical switching can be reduced, and is industrially applicable to a digital broadcast receiver allowing stress-free, continuous viewing at hierarchical switching.

1. A digital broadcast receiver comprising:
a digital broadcast receiving unit receiving digital broadcast including at least two hierarchical services;
a transport decoding unit decoding digital broadcast received by the digital broadcast receiving unit and outputting a video packet in a specific hierarchical service;
a video buffer accumulating a video packet output from the transport decoding unit;
a video decoder decoding a video packet accumulated in the video buffer;
a hierarchical switching determining unit determining a hierarchical service to be received from a reception state of digital broadcast received by the digital broadcast receiving unit; and
a system control unit controlling the hierarchical service for the video packet output from the transport decoding unit and controlling operation of the video decoder, based on the hierarchical service determined by the hierarchical switching determining unit,
wherein the system control unit stops decoding of the video packet by the video decoder when the transport decoding unit detects a given data after the hierarchical switching determining unit determines switching of the hierarchical service.

2. The digital broadcast receiver of claim 1, further comprising:
an audio buffer accumulating an audio packet; and
an audio decoder decoding the audio packet accumulated in the audio buffer,
wherein the transport decoding unit further decodes digital broadcast received by the digital broadcast receiving unit and outputs an audio packet in a specific hierarchical service, and
wherein the system control unit stops decoding of the audio packet when the transport decoding unit detects a given data after the hierarchical switching determining unit determines switching of the hierarchical service.

3. The digital broadcast receiver of claim 1, wherein the given data is an I frame by MPEG-2 video method.

4. The digital broadcast receiver of claim 1, wherein the given data is an IDR frame by H.264 MPEG-4 AVC method.

5. The digital broadcast receiver of claim 2, wherein the given data is an ADTS header by MPEG-2 AAC method.

6. The digital broadcast receiver of claim 1, wherein the system control unit stops decoding of the video packet by the video decoder when the video packet in the hierarchical service before switching are emptied in the video buffer after the hierarchical switching determining unit determines switching of the hierarchical service.

7. The digital broadcast receiver of claim 6, further comprising:
an audio buffer accumulating an audio packet; and
an audio decoder decoding an audio packet accumulated in the audio buffer,
wherein the transport decoding unit further decodes digital broadcast received by the digital broadcast receiving unit and outputs the audio packet in a specific hierarchical service to the audio buffer, and
wherein the system control unit stops decoding of the audio packet by the audio decoder when the audio packet for hierarchical service before switching are emptied in the audio buffer after the hierarchical switching determining unit determines switching of the hierarchical service.

8. The digital broadcast receiver of claim 1,
wherein at least two of the hierarchical services are at least high and low hierarchical services,
wherein the video buffer includes:
a first video buffer accumulating a video packet for the high hierarchical service output from the transport decoding unit; and
a second video buffer accumulating a video packet for the low hierarchical service output from the transport decoding unit,
wherein the video decoder decodes the video packet accumulated in one of the first video buffer and the second video buffer, and
wherein the system control unit stops decoding of the video packet before switching by the video decoder, when the video buffer before switching out of the first video buffer and the second video buffer becomes empty, when the transport decoding unit detects a given data, after the hierarchical switching determining unit determines switching of the hierarchical service.

9. The digital broadcast receiver of claim 8, further comprising:
a first audio buffer accumulating an audio packet for the high hierarchical service;
a second audio buffer accumulating an audio packet for the low hierarchical service; and
an audio decoder decoding the audio packet accumulated in one of the first audio buffer and the second audio buffer,
wherein the transport decoding unit further decodes digital broadcast received by the digital broadcast receiving unit and outputs the audio packet for the high hierarchical service and the audio packet for the low hierarchical service to the first audio buffer and the second audio buffer, respectively, and
wherein the system control unit stops decoding of the audio packet before switching by the audio decoder, when the audio buffer before switching out of the first audio buffer and the second audio buffer becomes empty, when the transport decoding unit detects a given data, after the hierarchical switching determining unit determines switching of the hierarchical service.

10. The digital broadcast receiver of claim 8, wherein the given data is an I frame by MPEG-2 video method.

11. The digital broadcast receiver of claim 8, wherein the given data is an IDR frame by H.264 MPEG-4 AVC method.

12. The digital broadcast receiver of claim 9, wherein the given data is an ADTS header by MPEG-2 AAC method.

13. The digital broadcast receiver of claim 1,
wherein at least two of the hierarchical services are at least high and low hierarchical services,
wherein the video buffer includes:
a first video buffer accumulating a video packet for the high hierarchical service output from the transport decoding unit; and
a second video buffer accumulating a video packet for the low hierarchical service output from the transport decoding unit,
wherein the video decoder decodes the video packet accumulated in one of the first video buffer and the second video buffer, and
wherein the system control unit stops decoding of the video packet before switching by the video decoder at a given time, after the hierarchical switching determining unit determines switching of the hierarchical service.

14. The digital broadcast receiver of claim 1,
wherein at least two of the hierarchical services are at least high and low hierarchical services, further comprising:
a first audio buffer accumulating an audio packet for the high hierarchical service;
a second audio buffer accumulating an audio packet for the low hierarchical service; and
an audio decoder decoding the audio packet accumulated in one of the first audio buffer and the second audio buffer,
wherein the transport decoding unit further decodes digital broadcast received by the digital broadcast receiving unit and outputs the audio packet for the high hierarchical service and the audio packet for the low hierarchical service to the first audio buffer and the second audio buffer, respectively, and
wherein the system control unit stops decoding of the audio packet before switching by the audio decoder at a given time, after the hierarchical switching determining unit determines switching of the hierarchical service.

15. The digital broadcast receiver of claim 13, wherein the given time is a time point that is the PTS of an IDR frame minus a time period required for the video decoder to decode video of an IDR frame by H.264 MPEG-4 AVC method.

16. The digital broadcast receiver of claim 14, wherein the given time is a time point that is the PTS of an IDR frame minus a time period required for the audio decoder to decode audio of an ADTS header by MPEG-2 AAC method.

17. A digital broadcast comprising:
a digital broadcast receiving unit receiving digital broadcast including at least tow hierarchical services;
a transport decoding unit decoding digital broadcast received by the digital broadcast receiving unit and outputting a video packet in a specific hierarchical service;
an audio buffer accumulating an audio packet; and
an audio decoder decoding the audio packet accumulated in the audio buffer,
wherein the transport decoding unit further decodes digital broadcast received by the digital broadcast receiving unit and outputs an audio packet in a specific hierarchical service and
wherein the system control unit stops decoding of the audio packet when the transport decoding unit detects a given data after the hierarchical switching determining unit determines switching of the hierarchical service.
